(19) United States
(12) Patent Application Publication
(10) Pub. No.: US 2013/0247441 A1
(43) Pub. Date: Sep. 26, 2013

(54) DECOY APPARATUS AND RELATED METHODS

(71) Applicants: Jason E. Bellamy, Calabash, NC (US); T. Wade Long, Little River, SC (US); Roy M. Smith, Little River, SC (US)

(72) Inventors: Jason E. Bellamy, Calabash, NC (US); T. Wade Long, Little River, SC (US); Roy M. Smith, Little River, SC (US)

(21) Appl. No.: 13/848,289

(22) Filed: Mar. 21, 2013

Related U.S. Application Data
(60) Provisional application No. 61/614,355, filed on Mar. 22, 2012.

(51) Int. Cl. A01M 31/06

(52) U.S. Cl. CPC A01M 31/06
USPC 43/2

(57) ABSTRACT

A decoy apparatus, which in various aspects; the decoy apparatus may include a motor adapted to rotate a decoy body in a plane of rotation. The decoy apparatus may include a clamp adapted to detachably secure a decoy appendage, and an appendage servo in mechanical cooperation with the clamp to move the clamp and decoy appendage secured within the clamp in a plane perpendicular to the plane of rotation. The decoy apparatus includes a power source adapted to provide electrical power to the motor and to provide electrical power to the appendage servo, in various aspects. In various aspects, the decoy apparatus includes a remote transmitter to generate wireless signals adapted to direct motions of the decoy body servo and the appendage servo. The decoy apparatus includes a controller adapted to receive the wireless signals, the controller cooperates with the power source, the motor servo, and the appendage servo to cause motions of the decoy body and the decoy appendage as directed by the wireless signals, in various aspects. This Abstract is presented to meet requirements of 37 C.F.R. §1.72(b) only. This Abstract is not intended to identify key elements of the apparatus and methods disclosed herein or to delineate the scope thereof.

### CROSS-REFERENCE TO RELATED APPLICATIONS

This U.S. utility patent application claims the priority and benefits of U.S. Provisional Application No. 61/614,355 entitled A WIRELESS REMOTE CONTROL APPARATUS USED TO CONTROL MOVEMENT OF AN ANIMAL DECOY ON TWO (2) AXIS, WITH THE PURPOSE TO ADD LIFE LIKE MOTION filed on 22 Mar. 2012, which is hereby incorporated by reference in its entirety herein.

### BACKGROUND OF THE INVENTION

1. Field of the Invention

The present disclosure relates to decoys and, more particularly, to movable decoys for the attraction of wild turkeys.

2. Description of the Related Art

Many decoys are stationary, and, accordingly, lack life-like motion. Game may be wary and may not approach a decoy that lacks movement so that such decoys may be ineffective in attracting game. While various decoys may be available that include movement, the movement may be generally one-dimensional and therefore not sufficiently realistic to attract game.

A search of the patent arts did not disclose any references that read directly on the claims of the instant invention; however, the following references were considered related:

U.S. Pat No. 5,029,408 published in the name of Randy J. Smith;

U.S. Pat No. 5,459,958 published in the name of Darrell D. Reinke;

U.S. Pat No. 6,487,810 B1 published in the name of Van Loughman;

U.S. Pat No. 6,574,902 B1 published in the name of Conger et al.;

U.S. Pat No. 6,658,782 published in the name of George W. Brint;

U.S. Pat No. 7,627,977 published in the name of Arthur Denny;

U.S. Patent Application no. 2004/0031185 A1 published in the name of Summers et al.;

U.S. Patent Application No. 2005.0204604 published in the name of Noles et al.; and

U.S. Patent Application No. 2011/0232153A1 published in the name of Jennings et al.

Accordingly, there is a need for improved decoy apparatus as well as related methods that are moveable in multiple dimensions.

### BRIEF SUMMARY OF THE INVENTION

These and other needs and disadvantages may be overcome by the decoy apparatus and related methods disclosed herein. Additional improvements and advantages may be recognized by those of ordinary skill in the art upon study of the present disclosure.

A decoy apparatus is disclosed herein. In various aspects, the decoy apparatus may include a motor adapted to rotate a decoy body in a plane of rotation. The decoy apparatus may include a clamp adapted to detachably secure a decoy appendage, and an appendage servo in mechanical cooperation with the clamp to move the clamp and decoy appendage secured within the clamp in a plane perpendicular to the plane of rotation. The decoy apparatus includes a power source adapted to provide electrical power to the motor and to provide electrical power to the appendage servo, in various aspects. In various aspects, the decoy apparatus includes a remote transmitter to generate wireless signals adapted to direct motions of the decoy body servo and the appendage servo. The decoy apparatus includes a controller adapted to receive the wireless signals, the controller cooperates with the power source, the motor servo, and the appendage servo to cause motions of the decoy body and the decoy appendage as directed by the wireless signals, in various aspects.

This summary is presented to provide a basic understanding of some aspects of the apparatus and methods disclosed herein as a prelude to the detailed description that follows below. Accordingly, this summary is not intended to identify key elements of the apparatus and methods disclosed herein or to delineate the scope thereof.

### BRIEF DESCRIPTION OF THE DRAWINGS

FIG. 1 illustrates by perspective view an exemplary implementation of a decoy apparatus;

FIG. 2 illustrates by schematic view portions of the exemplary implementation of a decoy apparatus of FIG. 1;

FIG. 3 illustrates by side view portions of the exemplary implementation of a decoy apparatus of FIG. 1; and

FIG. 4 illustrates by side view portions of the exemplary implementation of a decoy apparatus of FIG. 1.

The Figures are exemplary only, and the implementations illustrated therein are selected to facilitate explanation. The number, position, relationship and dimensions of the elements shown in the Figures to form the various implementations described herein, as well as dimensions and dimensional proportions to conform to specific force, weight, strength, flow and similar requirements are explained herein or are understandable to a person of ordinary skill in the art upon study of this disclosure. Where used in the various Figures, the same numerals designate the same or similar elements. Furthermore, when the terms “top,” “bottom,” “right,” “left,” “forward,” “rear,” “first,” “second,” “inside,” “outside,” and similar terms are used, the terms should be understood in reference to the orientation of the implementations shown in the drawings and are utilized to facilitate description thereof.

### DETAILED DESCRIPTION OF THE INVENTION

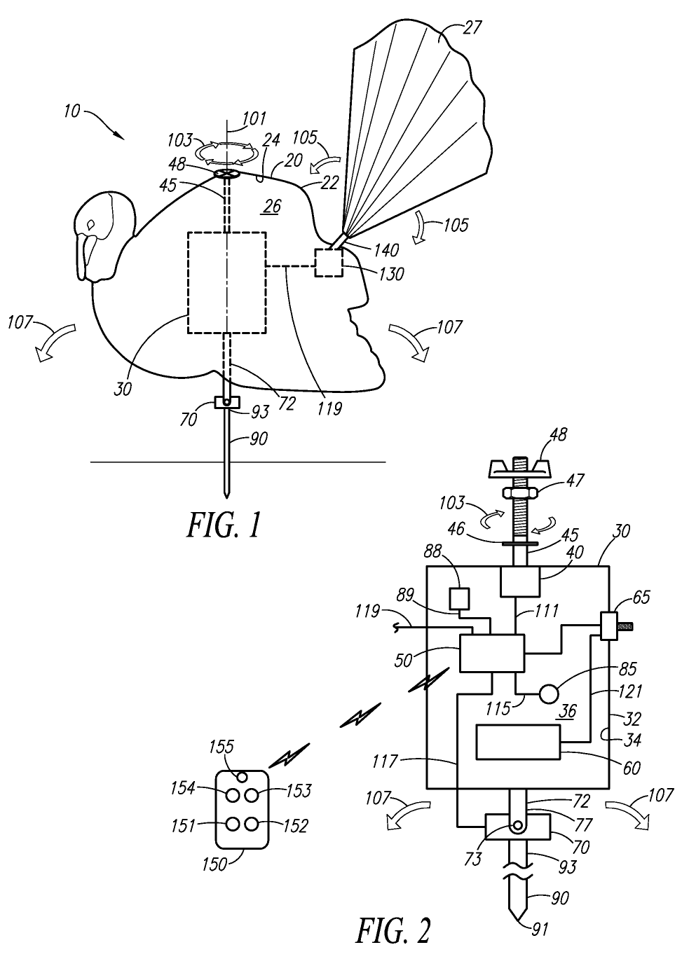

FIG. 1 illustrates an implementation of decoy apparatus 10. As illustrated in FIG. 1, decoy apparatus 10 includes a decoy body 20 with outer surface 22. Outer surface 22 of decoy body 20 may be configured such that decoy body 20 resembles at least a portion of a game bird or game animal such as a wild turkey, as illustrated in FIG. 1. Accordingly, outer surface 22 of decoy body 20 may be contoured in various ways, painted, textured, and so forth to lend outer surface 22 the desired appearance. Decoy body 20 may be formed of fiberglass, various plastics, wood, combinations thereof, and so forth, and decoy body 20 may be festooned with feathers, fur, or other natural or synthetic materials, as would be readily recognized by those of ordinary skill in the art upon study of this disclosures.

Inner surface 24 of decoy body 20 defines cavity 26 so that decoy body 20 is generally hollow to allow placement of various mechanisms therein, in this implementation. As illustrated in FIG. 1, decoy apparatus 10 includes compartment 30, which is positioned within cavity 20 of decoy body 20. Shaft 45, as illustrated, extends forth from compartment 30 to engage decoy body 20. Shaft 45 defines axis 101, and shaft 45 rotates about axis 101 thereby defining a plane of rotation perpendicular to axis 101. As axis 101 generally extends in the vertical direction, as illustrated, decoy body 20 rotates generally in the horizontal plane, as illustrated. When engaged with shaft 45, rotation of shaft 45 causes decoy body 20 to rotate about axis 101, as indicated by arrows 103, in this implementation.

Compartment 30 is further engaged with actuator arm 72 of decoy body servo 70. Decoy body servo 70 is, in turn, mounted to end 93 of stake 90, and stake point 91 of stake 90 may be driven into the ground, as illustrated in FIG. 1, to hold decoy body 20 in position. Decoy body servo 70 is an electromechanical device configured to move actuator arm 72 generally along an arc indicated by arrows 107 in the Figure. In various implementations, decoy body servo 70 may be an RC servo, and decoy body servo 70 may be controlled by digital control signals, analog control signals, or combinations thereof.

Stake 90 may be formed of metal such as steel or aluminum or various plastics, in various implementations. With stake point 91 driven into the ground, stake 90 supports the assembly of decoy body servo 70, actuator arm 72, compartment 30, shaft 45, and decoy body 20 in connection with one another, respectively, as illustrated in FIG. 1. Then, with stake point 91 of stake 90 driven into the ground, actuator arm 72 may be positioned by decoy body servo 70 between positions 75, 77, 79 (see FIG. 4) such that decoy body 20 is toggled back and forth along an arc lying generally in a vertical plane as indicated by arrows 107 in FIG. 1.

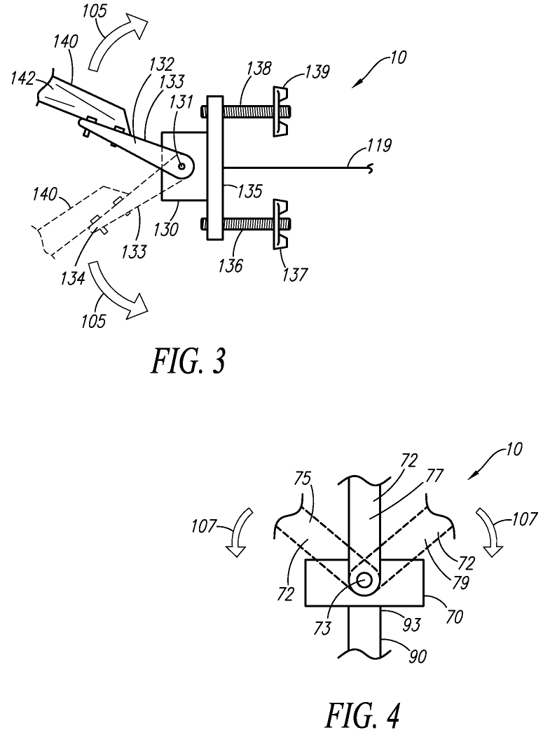

As illustrated in FIG. 1, decoy apparatus 10 includes appendage servo 130. Clamp 140 is operatively coupled to appendage servo 130, in this implementation, such that clamp 140 may be motioned by appendage servo 130 in the directions indicated by arrows 105 along with decoy appendage 27, which is removably received in clamp 140. Accordingly, as illustrated, decoy appendage 27, which is configured as the tail feathers of a turkey in this implementation, is generally motioned in a vertical plane. Note that the vertical plane in which the decoy appendage 27 is motioned is perpendicular to the horizontal plane in which decoy body 20 is rotated, in this implementation. Appendage servo 130 is an electromechanical device configured to move actuator arm 133 (see FIG. 3) generally along an arc indicated by arrows 107. In various implementations, appendage servo 130 is an RC servo, and appendage servo 130 may be controlled by either digital control signals or by analog control signals.

FIG. 2 illustrates portions of decoy apparatus 10 including compartment 30. As illustrated in FIG. 2, inner surface 34 of compartment 30 defines compartment cavity 36. Motor 40 is secured to inner surface 34 of compartment 30 such that shaft 45 extends forth from compartment 30. Motor 40 may be an electric motor generally configured to rotate shaft 45. As illustrated in the implementation of FIG. 2, shaft 45 may be threaded, at least in part, and both nut 47 and wing nut 48 are threadedly received thereupon. Stop 46 is provided along shaft 45 to limit the traversal of nut 47 and wing nut 48 along shaft 45. Shaft 45 may be passed through a hole (not shown) in decoy body 20 and the decoy body may be engaged between nut 47 and wing nut 48 such that nut 47 is biased against inner surface 24 and wing nut 48 is biased against outer surface 22 to secure removably the decoy body 20 to the shaft 45. With the decoy body 20 so secured to shaft 45, rotation of shaft 45 by motor 40 causes decoy body 20 to rotate, as indicated by arrows 103 in FIG. 1. Other methods of attachment may be used to secure decoy body 20 to shaft 45, in other implementations.

Controller 50 is in electrical communication with power supply 60 by pathway 121. Pathway 121 passes through switch 65, and switch 65, which is mounted to outer surface 32 of compartment 30 in this implementation, may be toggled by a user between an off position and an on position to control the flow of electrical power from power supply 60 to controller 50.

Controller 50 is in electrical communication with motor 40 by pathway 111, in electrical communication with decoy body servo 70 by pathway 117, in electrical communication with appendage servo 130 by pathway 119, in electrical communication with scent distributor 85 by pathway 115, and in electrical communication with sound generator 88 by electrical pathway 89 to control the flow electrical power from power supply 60 to motor 40, decoy body servo 70, appendage servo 130, scent distributor 85, and sound generator 88, and to control the operation of motor 40, decoy body servo 70, appendage servo 130, scent distributor 85, and sound generator 88. Controller 50 may transmit analog control signals, digital control signals, or combinations thereof along pathways 89, 111, 115, 117, 119 to control the operation of sound generator 88, motor 40, scent distributor 85, decoy body servo 70, or appendage servo 130, respectively. For example, controller 50 may transmit analog control signals, digital control signals, or combinations thereof along pathway 117 to control the positioning of actuator arm 72 by decoy body servo 70 such that decoy body servo 70 positions actuator arm 72 between position 75, 77, 79 or at positions intermediate of positions 75, 77, 79. For example, controller 50 may transmit analog control signals, digital control signals, or combinations thereof along pathway 119 to control the positioning of actuator arm 133 by appendage servo 130 such that appendage servo 130 positions actuator arm 133 between position 132 and position 134 or at positions intermediate of positions 132, 134.

Controller 50 is adapted to receive wireless signals from wireless transmitter 150 with the wireless signals adapted to direct controller 50 to cause the motor 40 to rotate shaft 45, decoy body servo 70 to position actuator arm 72, appendage servo 130 to position actuator arm 133 (see FIG. 3), activate scent distributor 85 to release scent, and activate sound generator 88 to generate sound. Accordingly, the operation of motor 40, decoy body servo 70, appendage servo 130, scent distributor 85, and sound generator 88 may be controlled by wireless transmitter 150 through wireless communications of wireless signals between wireless transmitter 150 and controller 50.

For example, the user may push button 151 on remote transmitter 150 thereby transmitting a wireless signal from remote transmitter 150 to controller 50, the wireless signal causing controller 50 to activate motor 40 thereby rotating the decoy body 20 as indicated by arrows 103 in FIG. 1. In various implementations, the user may be able to control the rate of rotation of the decoy body 20 by motor 40. The user, for example, may push button 152 on remote transmitter 150 thereby transmitting a wireless signal from remote transmitter 150 to controller 50, the wireless signal causing controller 50 to activate motor decoy body servo 70 thereby toggling the decoy body 20 back and forth as indicated by arrows 107 in FIG. 1. In various implementations, the user may be able to control the rate at which the decoy body 20 is toggled or the length of the arc along which the decoy body is toggled. The user, for example, may push button 153 on remote transmitter 150 thereby transmitting a wireless signal from remote transmitter 150 to controller 50, the wireless signal causing controller 50 to activate appendage servo 130 thereby motioning decoy appendage 27 as indicated by arrows 105 in FIG. 1. The user may be able to control the rate at which decoy appendage 27 is motioned or the length of the path along which decoy appendage 27 is motioned, in various implementations. Button 154 may initiate the transmission of wireless signals from remote transmitter 150 to controller 50 that, in turn, cause controller 50 to activate scent distributor 85, and the user may be able to control the quantity of scent that is released. Button 155 may initiate the transmission of wireless signals from remote transmitter 150 to controller 50 that, in turn, cause controller 50 to activate sound generator 88 thereby generating sounds, respectively. The user may be able to control the magnitude or type of sound that is generated, in various implementations.

Power source 60 may comprise one or more batteries of a standard size such as A, AA, D, combinations thereof, in various implementations. Sound generator 88 is adapted to make various sounds that may be attractive to the game bird or game animal. The type of sound may be selected by the user, and the magnitude of the sound may be selected by the user. Scent generator 85 is adapted to release various scents that may be attractive to the game bird or game animal. The type of scent or the quantity of scent released may be user selectable, in various implementations.

FIG. 3 illustrates portions of decoy apparatus 10 including appendage servo 130. As illustrated in FIG. 3, appendage servo 130 is mounted to plate 135, and plate 135 may be mounted to decoy body 20 using threaded fasteners 136, 138 and wing nuts 137, 139 that are threadedly received upon fasteners 136, 138, respectively. Threaded fasteners 136, 138 may be passed through holes (not shown) disposed about decoy body 20 for that purpose and wing nuts 137, 139 tightened thereupon to bias plate 135 against outer surface 22 of decoy body and wing nuts 137, 139 against inner surface 24 of decoy body to secure plate 135 to decoy body 20. With plate 135 so secured to decoy body 20, actuator arm 133 extends forth from decoy body 20 as does clamp 140, which is secured to actuator arm 133, as illustrated in FIG. 3. Appendage servo 130 may be mounted to decoy body 20 in other ways, and other types of fasteners or fastener systems may be used to secure appendage servo 130 to decoy body 20, in various other implementations.

Decoy appendage 27 (see FIG. 1) may be removably inserted into clamp 140 through clamp entry 143 such that portions of clamp 140 biases about portions of decoy appendage 27 to secure frictionally decoy appendage 27 within clamp 140. Appendage servo 130 may position actuator arm 133 including clamp 140 and decoy appendage 27 secured within clamp 140 between position 132 (illustrated in solid) and position 134 (illustrated in phantom) to motion decoy appendage 27 as indicated by arrows 105, as illustrated in FIG. 3.

FIG. 4 illustrates a portion of decoy apparatus including decoy body servo 70. As illustrated in FIG. 4, decoy body servo 70 is mounted proximate end 93 of stake 90, and actuator arm 72 is secured pivotally to decoy body servo 70 about pivot 73. As illustrated in FIG. 4, decoy body servo 70 may pivot actuator arm 72 about pivot 73 to position actuator arm including decoy body 20 connected thereto between position 75 (illustrated in phantom), position 77 (illustrated in solid), and position 79 (illustrated in phantom) to toggle decoy body 20 back and forth along the arc indicated by arrows 107.

In operation, in some implementations the decoy apparatus 10 may be provided to the user completely assembled with decoy body 20 mounted to shaft 45 and with appendage servo 130 including actuator arm 133 and clamp 140 secured to decoy body 20. In other implementations, the user may assemble at least portions of decoy apparatus 10 by mounting decoy body 20 upon shaft 45 and by securing appendage servo 130 including actuator arm 133 and clamp 140 to decoy body 20 in order to retrofit various portions of decoy apparatus 10 to a decoy body 20.

For example, the user may secure decoy body 20 to shaft 45 by passing shaft 45 through a hole (not shown) in decoy body 20 and engaging the decoy body 20 between nut 47 and wing nut 48 such that nut 47 is biased against inner surface 24 and wing nut 48 is biased against outer surface 22. In some implementations, the hole through which shaft 45 is passed is provided in decoy body 20, while, in other implementations, the user drills the hole through decoy body 20 and then passes shaft 45 therethrough. In still other implementations, decoy body 20 is provided to the user with the decoy body 20 mounted upon shaft 45.

The user may mount plate 135 to decoy body 20 by passing fasteners 136, 138 through holes (not shown) disposed about decoy body 20 for that purpose and tightening wing nuts 137, 139 against inner surface 24 of the decoy body 20 to bias plate 135 against outer surface 22 of decoy body 20 thereby securing plate 135 to decoy body 20. When plate 135 is secured to decoy body 20, actuator arm 133 with clamp 140 secured thereto extends forth from decoy body 20. In some implementations, the holes through which fasteners 136, 138 are passed are provided in decoy body 20, while, in other implementations, the user drills holes through decoy body 20 and then passes fasteners 136, 138 therethrough. In still other implementations, appendage servo 130 including actuator arm 133 and clamp 140 are provided to the user pre-mounted to decoy body 20.

With decoy body 20 mounted to shaft 45 and with appendage servo 130 including actuator arm 133 and clamp 140 mounted to decoy body 20, stake point 91 of stake 90 may be driven into the ground to support decoy apparatus 10 at a desired location. The user may insert decoy appendage 27 into clamp 140. The user may toggle switch 65 from the off position to the on position to activate controller 50 to connect controller 50 with power supply 60 in order to activate controller 50. The user may toggle switch 65 from the on position to the off position to disconnect controller 50 from power supply 60 in order to deactivate controller 50.

With decoy apparatus 10 situated at the desired location and controller 50 activated by positioning switch 65 in the on position, the user may retreat to a concealed location where the user may transmit wireless signals from remote transmitter 150 to controller 50 to direct controller 50 to cause the motor 40 to rotate shaft 45, to cause decoy body servo 70 to position actuator arm 72, to cause appendage servo 130 to position actuator arm 133 (see FIG. 3), to activate scent distributor 85, or to activate sound generator 88, as desired by the user. The user may direct the decoy body 20 to rotate, may direct motioning of the decoy appendage 27, or may direct toggling of the decoy body 20. The rotation of the decoy body 20, the motioning of the decoy appendage 27, and the toggling of the decoy body 20 may be consecutive, simultaneous, or combinations thereof, as directed by the user.

Toggling of the decoy body 20 occurs in a plane generally perpendicular to the plane within which the decoy body 20 rotates. The decoy appendage 27 is motioned in generally the same plane as the decoy body 20 is toggled (the vertical plane), in this implementation, but decoy appendage 27 may be motioned in various other planes having various orientations, in other implementations. The decoy body 20 may be rotated or the decoy body 20 may be toggled in various other planes or combination of planes, in various other implementations.

The user may withdraw stake 90 from the ground to relocate decoy apparatus 10. The user may disassemble decoy apparatus 10 in part by removing shaft 45 from decoy body 20 by disengaging wing nut 48 and then removing shaft 45 from the hole in the decoy body 20. The user may disassemble decoy apparatus 10 in part by removing decoy appendage 27 from clamp 140. The user may disassemble decoy apparatus 10 in part by removing plate 135 from decoy body 20 thereby removing appendage servo 130, actuator arm 133, and clamp 140 from decoy body 20.

The foregoing discussion along with the Figures discloses and describes various exemplary implementations. These implementations are not meant to limit the scope of coverage, but, instead, to assist in understanding the context of the language used in this specification and in the claims. Upon study of this disclosure and the exemplary implementations herein, one of ordinary skill in the art may readily recognize that various changes, modifications and variations can be made thereto without departing from the spirit and scope of the inventions as defined in the following claims.

The invention claimed is:

1. A decoy apparatus, comprising:
a motor, the motor adapted to rotate a decoy body in a plane of rotation;
a clamp adapted to detachably secure a decoy appendage;
an appendage servo in mechanical cooperation with the clamp to move the clamp and decoy appendage secured within the clamp in a plane perpendicular to the plane of rotation;
a power source adapted to provide electrical power to the motor and to provide electrical power to the appendage servo;
a remote transmitter to generate wireless signals adapted to direct motions of the decoy body servo and the appendage servo; and
a controller adapted to receive the wireless signals, the controller cooperates with the power source, the motor servo, and the appendage servo to cause motions of the decoy body and the decoy appendage as directed by the wireless signals.

2. The apparatus as in claim 1, wherein the motor, the clamp, the appendage servo, the power source, and the controller are adapted for retrofit to the decoy body.

3. The apparatus as in claim 1, further comprising:
a decoy body servo in cooperation with the controller and in cooperation with the decoy body to toggle the decoy body in a vertical plane as directed by the remote transmitter.

4. The apparatus as in claim 3, wherein the clamp and decoy appendage secured within the clamp are moved in the vertical plane.

5. The apparatus as in claim 1, wherein the plane of rotation is a horizontal plane.

6. The apparatus as in claim 1, further comprising:
a sound generator in cooperation with the controller, the sound generator adapted to generate sounds as directed by the remote transmitter.

7. The apparatus as in claim 1, further comprising:
a scent distributor in cooperation with the controller and adapted to release scent as directed by the remote transmitter.

8. A decoy apparatus, comprising:
a decoy body having an internal receiving cavity;
a motor received within the cavity of the decoy body, the motor adapted to move the decoy body rotatably in a horizontal plane;
a clamp adapted to secure a decoy appendage of the decoy therein;
an appendage servo in mechanical cooperation with the clamp to move the clamp and decoy appendage secured within the clamp in a vertical plane, the appendage servo secured to the decoy body;
a power source received within the cavity, the power source adapted to provide electrical power to the motor and to provide electrical power to the appendage servo;
a remote transmitter adapted to transmit wireless signals; and
a controller received within the cavity, the controller adapted to receive wireless signals wireles sly from the remote transmitter, the controller cooperates with the power source, the motor, and the appendage servo to cause motions of the motor and the appendage servo as directed by the wireless signals.

9. The apparatus as in claim 8, wherein the motor, the clamp, the appendage servo, the power source, and the controller are adapted for retrofit to the decoy body.

10. The apparatus as in claim 8, further comprising:
a decoy body servo in cooperation with the controller and in cooperation with the decoy body to toggle the decoy body in a vertical plane as directed by the remote transmitter.

11. The apparatus as in claim 10, wherein the clamp and decoy appendage secured within the clamp are moved in the vertical plane.

12. The apparatus as in claim 8, wherein the plane of rotation is a horizontal plane.

13. The apparatus as in claim 8, further comprising:
a sound generator in cooperation with the controller, the sound generator adapted to generate sounds as directed by the remote transmitter.

14. The apparatus as in claim 8, further comprising:
a scent distributor in cooperation with the controller and adapted to release scent as directed by the remote transmitter.

15. A method of decoying game, comprising the steps of:
rotating a decoy body in a rotational plane using a motor disposed within a cavity of the decoy body;
moving a decoy appendage in a plane perpendicular to the rotational plane using an appendage servo secured to the decoy body; and
directing the rotation of the decoy body and the moving of the decoy appendage using a remote transmitter, the remote transmitter in wireless communication with the motor and in wireless communication with the appendage servo to direct motions of the motor and the appendage servo.

16. The method of claim 15, further comprising the step of:
toggling the decoy body using a decoy body servo operatively connected to the decoy body, the decoy body servo in wireless communication with the remote transmitter such that the remote transmitter directs motions of the decoy body servo.

17. The method of claim 15, further comprising the step of:
generating sound using a sound generator disposed about the decoy body, the sound generator in wireless communication with the remote transmitter such that the remote transmitter directs the generating of sound by the sound generator.

18. The method of claim 15, further comprising the step of:
releasing a scent using a scent distributor disposed about the decoy body, the scent distributor in wireless communication with the remote transmitter such that the remote transmitter directs the release of scent by the scent distributor.

19. The method of claim 15, further comprising the steps of:
inserting the motor within the cavity of the decoy body; and
securing the appendage servo to the decoy body.
